(19) United States
(12) Patent Application Publication
(10) Pub. No.: US 2005/0153654 A1
(43) Pub. Date: Jul. 14, 2005

(54) Method and system for leaving a communication channel in a wireless communications system

(76) Inventors: Jon J. Anderson, Boulder, CO (US); Bijan Tuysserkani, Boulder, CO (US)

Correspondence Address: Qualcomm Incorporated;Patents Department, 5775 Morehouse Drive, San Diego, CA, 92121-1714, US

(21) Appl. No.: 11/051,057

(22) Filed: Feb. 4, 2005

Related U.S. Application Data
(62) Division of application No. 10/216,490, filed on Aug. 9, 2002.

(51) Int. Cl. H04B 7/185

(52) U.S. Cl. 455/12.1; 455/456.1

(57) ABSTRACT

A method and system for reliably returning to a traffic channel in a wireless communications system having at least one communication channel, after performing E911 GPS or other types of signal measurements is provided. A communications link is established using a device in the communications system configured to establish communication over the communication channel, which also includes a processor and a tuner. Communication is based upon receiving a first radio frequency (RF) signal including data frames. The method includes tuning to receive a second RF signal, which action interrupts reception of the first RF signal. Communication over the communication channel is maintained during the interruption. The method also includes processing data frames during the tuning, updating a signal search space associated with the first RF signal during processing, and searching for the first RF signal within the updated search space, so that the first RF signal is then re-acquired.

### CLAIM OF PRIORITY UNDER 35 U.S.C. §120

The present Application for Patent is a Divisional and claims priority to patent application Ser. No. 10/216,490 entitled “METHOD AND SYSTEM FOR LEAVING A COMMUNICATION CHANNEL IN A WIRELESS COMMUNICATIONS SYSTEM” filed Aug. 9, 2002, and assigned to the assignee hereof and hereby expressly incorporated by reference herein.

### BACKGROUND OF THE INVENTION

### BACKGROUND

1. Field

The present invention generally relates to wireless communications networks. More particularly, the present invention relates to a system and method for leaving a traffic channel in a terrestrial mobile or satellite wireless communications system.

2. Background

There are presently many different types of radiotelephone or wireless communication systems, including different terrestrial based wireless communication systems and different satellite based wireless communication systems. The different terrestrial based wireless systems can include Personal Communications Service (PCS) and cellular systems. Examples of known cellular systems include the cellular Analog Advanced Mobile Phone System (AMPS), and the following digital cellular systems: Code Division Multiple Access (CDMA) systems; Time Division Multiple Access (TDMA) systems; and newer hybrid digital communication systems using both TDMA and CDMA technologies.

The use of CDMA techniques in a multiple access communication system is disclosed in U.S. Pat. No. 4,901,307 issued Feb. 13, 1990 to Gilhousen et al., entitled “Spread Spectrum Multiple Access Communication System Using Satellite Or Terrestrial Repeaters” and U.S. Pat. No. 5,103,459, issued Apr. 7, 1992 to Gilhousen et al., entitled “System And Method For Generating Signal Waveforms In A CDMA Cellular Telephone System,” both of which are assigned to the assignee of the present invention and are incorporated herein by reference.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TLA/EIA Standard IS-98. Other communications systems are described in the IMT-2000/UM, or International Mobile Telecommunications System 2000/Universal Mobile Telecommunications System, standards covering what are referred to as Wideband CDMA (WCDMA), cdma2000 (such as cdma2000 1x or 3x standards, for example) or TD-SCDMA.

In the above patents, CDMA techniques are disclosed in which a large number of mobile station users, each having a transceiver, communicate through satellite repeaters or terrestrial base stations. The satellite links and gateways are received through terrestrial base stations. The gateways or base stations provide communication links for connecting a user terminal to other user terminals or users of other communications systems, such as a public telephone switching network. By using CDMA communications, the frequency spectrum can be used by multiple terminals, thereby permitting an increase in system user capacity. The use of CDMA techniques results in much higher spectral efficiency than can be achieved using other multiple access techniques.

In a typical CDMA communications system, both the remote units and the base stations discriminate the simultaneously received signals from one another using modulation and demodulation of the transmitted data with high frequency Pseudo-Noise (PN) codes, orthogonal Walsh codes, or both. For example, in the forward link, i.e., base station to mobile station direction, IS-95 separates transmissions from the same base station by the use of different Walsh codes for each transmission, while the transmissions from different base stations are distinguished by the use of a uniquely offset PN code. In the reverse link, i.e., mobile station to base station direction, different PN sequences are used to distinguish different channels.

The forward CDMA link includes a pilot channel, a synchronization (sync)-channel, several paging channels, and a larger number of traffic channels. The reverse link includes an access channel and a number of traffic channels. The pilot channel transmits a Radio Frequency (RF) beacon signal, known as a pilot signal, and is used to alert mobile stations of the presence of a CDMA compliant base station. The pilot signal is initially received by an RF receive path of the mobile station. After having successfully acquired the pilot signal, the mobile station can then receive and demodulate the sync-channel in order to achieve frame level synchronization and system time, etc. The synch channel carries a repeating message that specifically identifies the base station, provides system level timing, and provides the absolute phase of the pilot signal. This feature will be discussed in greater detail below. The paging channel is used by the base station to assign communication channels and to communicate with the mobile station when it has not been assigned to a traffic channel. Individual mobile stations, however, are eventually assigned to a specific traffic channel. Traffic channels are used to carry user communications traffic, such as speech and data.

To communicate properly in a CDMA system, the state of the particular codes selected must be synchronized at the base station and mobile station. Code level synchronization is achieved when the state of the codes at the mobile station system are the same as those in the base station, less some offset to account for processing and transmission delays. In IS-95, such synchronization is facilitated by the transmission of the pilot signal, which comprises the repeated transmission of the uniquely offset PN code (pilot PN code), from each base station. In addition to facilitating synchronization at the Pilot PN code level, the pilot channel allows identification of each base station relative to the other base stations located around it using the pilot channel phase offset. The pilot channel, therefore, provides the mobile station with access to a first level of detailed PN sequence timing information.

Mobile stations initially acquire an IS-95 based communications system by searching for a valid pilot signal within a definable search window. Pilot signals associated with different base stations are distinguished from one another on the basis of the phase of the pilot signal. Thus, although each base station transmits an identical pilot signal, pilot signals from different base stations have different phases. A 9-bit number can be used to identify the pilot phase and is called the pilot offset.

After a mobile phone has acquired a pilot signal and has associated that pilot signal with a particular base station, the mobile station can receive and demodulate the sync channel. In addition to providing the mobile station with the phase of the pilot signal and identification of its associated base station, the synchronization message also includes CDMA system level timing information. Although system time can be provided through a number of different timing sources, traditional wireless communication systems derive system timing information through the Global Positioning System (GPS) satellite system.

Due in part to convenience and availability of mobile phones, the Federal Communications Commission (FCC) now requires that Wireless Communication System (WCS) providers implement a mechanism to automatically route 911 calls to the nearest emergency services processing center along with position of the user. This is referred to as the E911 requirement. The user's position is also useful in accommodating other wireless communications applications. In order to accommodate the E911 requirements and other applications, the WCS must be able to quickly and accurately determine the geographic position of a mobile phone.

The user's geographic position, required for example to support E911, is often derived by GPS measurements. Multi-mode mobile phones are one conventional mechanism for performing the GPS measurements and accommodating the E911 requirements. Multi-mode phones include one or more processors and are switchable between a single RF receive path that includes a tuner, among other things. One processor supports normal communication and another processor can support, for example, the GPS measurements. To facilitate the E911 user position measurements, the tuner temporarily switches from a communications signal frequency to a GPS signal frequency in order to receive a GPS signal. Therefore, if the mobile phone is required to process an E911 call during an ongoing communications call, the ongoing communications call will be profoundly impacted. The degree of the impact can range from minimal to complete loss of the communications call or link.

During a communications call in a conventional WCS, the communications processor uses the traffic channel for transmission of communications data and speech, as noted above. When the tuner tunes to receive the GPS signal, the communications processor essentially leaves the traffic channel for a period of time. The length of the period of time includes time required for the GPS processor to complete the GPS measurements and return to the correct traffic channel. Restoring the interrupted communications call includes, for example, receiving the associated pilot signal, demodulating the synchronization channel, and resuming communications over the assigned traffic channel. This process can be problematic, time consuming, and complicated by Doppler and other signal degradation mechanisms, especially depending upon the amount of time needed to complete the GPS measurements.

What is needed, therefore, is a system and method to eliminate the shortcomings of the conventionally used techniques of resuming communications over the traffic channel after E911 or other GPS measurements. In particular, what is needed is a system and method of facilitating GPS measurements without losing communication over the traffic channel.

### SUMMARY

A method and apparatus establish a communications link using one or more devices, such as a wireless telephone or modem, in a communications system having at least one communication channel, such as a traffic channel. The device comprises a processor or controller and a tuner or receiving element, and is configured to establish communication over a communication channel based upon receiving a first RF signal generally including data frames.

In one embodiment, the method comprises tuning to receive a second RF signal including data frames, wherein the tuning step interrupts reception of the first RF signal, and operations can occur on the second RF signal. The second RF signal can be one associated with obtaining device position location information, possibly within a wireless communication system. In one embodiment, the position location information supports an E911 or other emergency communication service or requirement. The communications link is maintained during the interruption of the first RF signal. The method also includes processing the second RF signal during the tuning, and updating a signal search space associated with the first RF signal. The communications system searches for the first RF signal within the updated search space and re-acquires, or attempts to re-acquire, the first RF signal in accordance with the searching. The reacquiring step facilitates maintenance of the communication link.

Alternatively, the device includes a demodulator and the method comprises interrupting the communication at a selected or scheduled time for an interruption period, tuning to receive the second RF signal during the interruption period, determining signal acquisition parameters associated with the first RF signal after the interruption period concludes; and re-acquiring the first RF signal in accordance with the determined signal acquisition parameters. In some embodiments, the method comprises resuming communication over the communication channel when the first RF signal is re-acquired. The demodulator may be deactivated during the interruption period. In another embodiment the interrupting includes maintaining tracking parameters associated with the first RF signal; and the updating includes updating the maintained tracking parameters. The device can be performing an inter-system handoff measurement during this processing.

In one embodiment, determining signal acquisition parameters comprises calculating a first RF signal Doppler, calculating a present system time, and calculating a search space for the first RF signal. Calculating the first RF signal Doppler may include quantifying an amount of error, the amount of error including at least one from a group including motion error and synthesizer clock error. The scheduled time can be an initial system time, in which case calculating the present system time includes advancing the initial system time by an amount equal to a sum of the interruption period and the quantified amount of error, with the advanced initial system time defining the present system time.

Further embodiments of the method comprise storing identification and state data associated with the communication channel, tuning to receive a second RF signal when the identification data is stored, which interrupts reception of the first RF signal for a period of time re-acquiring the first RF signal after the period of time concludes retrieving the stored identification and state data when the first RF signal is reacquired, and resuming the communication in accordance with the retrieved identification and state data. The identification data can include a pilot signal phase, identification of at least one of an associated base station and a satellite beam, identification of a traffic channel, and a type of service. The re-acquiring step can also include determining a first RF signal search space, searching within the determined first RF signal search space, and selecting the first RF signal during the search.

In some embodiments, the first and second RF signals are associated with different communications from wireless communications system such as a terrestrial mobile, low-earth orbit, spread spectrum, code division multiple access, wideband code division multiple access, or a global system for mobile communications system.

In one embodiment, the apparatus comprises means for tuning to receive a second RF signal including data frames, wherein the means for tuning interrupts reception of the first RF signal, while communication over the communication channel is maintained during the interruption. The second RF signal can be one associated with obtaining device position location information, possibly within a wireless communication system. In one embodiment, the position location information supports an E911 or other emergency communication requirement or service. Alternatively, other position location services can be supported.

The apparatus further comprises means for processing data frames during the tuning, means for updating a signal search space associated with the first RF signal during the processing, means for searching for the first RF signal within the updated search space, and means for attempting to re-acquire the first RF signal in accordance with the searching, the reacquiring facilitating maintenance of the communication link. In further embodiments, the means for processing includes one or more circuit types such as dedicated function circuit modules, application specific integrated circuits, software defined radios, and field programmable gate arrays. Each of the one or more circuit types may be associated with one communications system from a group of communications systems.

In further embodiments, the device comprises a demodulator, means for interrupting the communication at a scheduled time for a selected interruption period, means for tuning to receive a second RF signal during the interruption period, means for determining signal acquisition parameters associated with the first RF signal after the interruption period concludes, and means for attempting to re-acquire the first RF signal in accordance with the determined signal acquisition parameters.

The apparatus may further comprise means for storing identification and state data associated with the communication channel; means for tuning to receive a second RF signal when the identification data is stored, the means for tuning interrupting reception of the first RF signal for a period of time; means for re-acquiring the first RF signal after the period of time concludes; means for retrieving the stored identification and state data when the first RF signal is reacquired; and means for resuming the communication in accordance with the retrieved identification and state data.

The invention can be implemented in some embodiments using a computer readable medium carrying one or more sequences of one or more instructions for execution by one or more processors included in a system configured to establish a communications link using a device that comprises a processor or controller and a tuner or receiver and/or transceiver configured to establish communication over a communication channel based upon receiving a first RF signal, the instructions when executed by the one or more processors, cause the one or more processors to perform the steps of tuning the device to receive a second RF signal including data frames; interrupting reception of the first RF signal during the tuning step for a selected period, the communication over the communication channel being maintained during the interruption; processing the data frames during the tuning step; updating a signal search space associated with the first RF signal during the processing step; searching for the first RF signal within the updated search space; and attempting to re-acquire the first RF signal in accordance with the searching to facilitate maintenance of the communication link, or resuming communication over the communication channel when the first RF signal is re-acquired. In some embodiments the demodulator is deactivated during the interruption period.

When the embodiment comprises a demodulator, the one or more sequences of one or more instructions for a computer readable medium may cause the execution of the steps of interrupting the communication at a scheduled time for an interruption period; tuning to receive a second RF signal during the interruption period; determining signal acquisition parameters associated with the first RF signal after the interruption period concludes; and attempting to or re-acquiring the first RF signal in accordance with the determined signal acquisition parameters.

In further embodiments the instructions for a computer readable medium may cause the execution of the steps of storing identification and state data associated with the communication channel; tuning to receive a second RF signal when the identification data is stored, the tuning interrupting reception of the first RF signal for a period of time; re-acquiring the first RF signal after the period of time concludes; retrieving the stored identification and state data when the first RF signal is reacquired; and resuming the communication in accordance with the retrieved identification and state data.

Features and advantages of the embodiments include an ability to process an E911 type emergency call without losing ongoing communications with a 911 operator. These features can be easily incorporated into existing mobile phone systems and related software code base. The method and system of embodiments of the invention also include an ability to reacquire the traffic channel, in the event of complete loss of the communications call, within a minimal amount of time. Finally, apparatus can also be configured to re-establish communication over the traffic channel before the invocation of fade timers, thus preventing additional call interruptions.

Further embodiments, features, and advantages of the present invention, as well as the structure and operation of the various embodiments of the present invention, are described in detail below with reference to the accompanying drawings.

### BRIEF DESCRIPTION OF THE DRAWINGS

The accompanying drawings, which are incorporated in and constitute a part of the specification, illustrate an embodiment of the invention and, together with the description, explain the purpose, advantages, and principles of the invention. In the drawings:

FIG. 1 illustrates an exemplary wireless communication system;

FIG. 2 is a diagram illustrating an exemplary satellite footprint having a plurality of beams;

FIG. 3 is an illustration of an exemplary multi-mode mobile phone;

FIG. 4 is a block diagram illustration of a multi-mode mobile phone of FIG. 3;

FIG. 5 is an illustration of an exemplary timing diagram depicting an acquisition process;

FIG. 6 is a flow chart of a method of acquiring a communications channel during an emergency mode;

FIG. 7 is a flow chart of a method of acquiring a communications channel during a cold acquisition mode; and

FIG. 8 is a flow chart of a method of acquiring a communications channel based upon a preprogrammed interruption.

### DETAILED DESCRIPTION

The following detailed description of embodiments of the present invention refers to the accompanying drawings that illustrate exemplary embodiments consistent with this invention. Other embodiments are possible, and modifications may be made to the embodiments within the spirit and scope of the invention. Therefore, the following detailed description is not meant to limit the invention. Rather, the scope of the invention is defined by the appended claims.

It would be apparent to one of skill in the art that the embodiments, as described below, may be implemented in many different embodiments of hardware, software, firmware, and/or the entities illustrated in the figures. Any actual software code with specialized controlled hardware to implement the present invention is not limiting of the present invention. Thus, the operation and behavior of the present invention will be described with the understanding that modifications and variations of the embodiments are possible, given the level of detail presented herein.

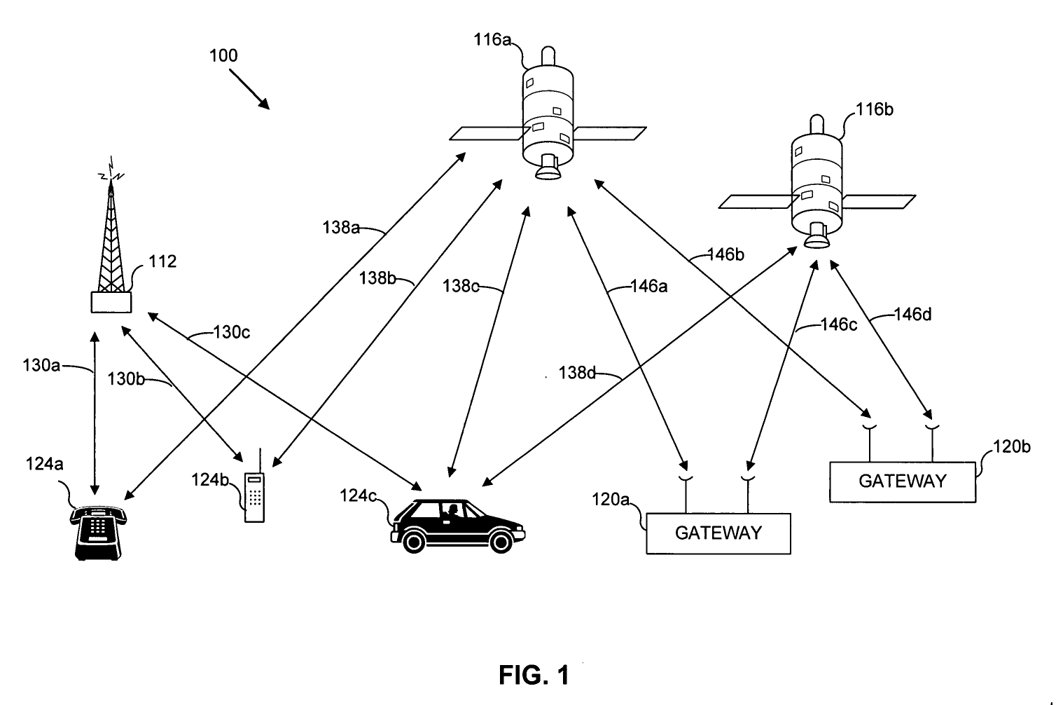

Before describing embodiments of the invention in detail, it is helpful to describe an example environment in which the invention may be implemented. The present invention is particularly useful in mobile communications environments. FIG. 1 illustrates such an environment.

FIG. 1 is a block diagram of an exemplary WCS 100 that includes a base station 112, two satellites 116a and 116b, and two associated gateways (also referred to herein as hubs) 120a and 120b. These elements engage in wireless communications with user terminals 124a, 124b, and 124c. Typically, base stations and satellites/gateways are components of distinct terrestrial and satellite based communication systems. However, these distinct systems may interoperate as an overall communications infrastructure.

Base stations 112 may form part of terrestrial-based communication systems and networks that include a plurality of PCS/cellular communication cell-sites. Base stations 112 can be associated with a terrestrial based CDMA or TDMA (or hybrid CDMA/TDMA) digital communication system, transmitting or receiving terrestrial CDMA or a TDMA signals to or from a mobile user terminal. The terrestrial signal can be formatted in accordance with IMT-2000/UMT standards (that is, International Mobile Telecommunications System 2000/Universal Mobile Telecommunications System standards). The terrestrial signal can be a wideband CDMA signal (referred to as a WCDMA signal), or a signal conforming to cdma2000 standards (such as cdma2000 1x or 3x standards, for example), or a TD-SCDMA signal. On the other hand, base stations 112 can be associated with an analog based terrestrial communication system (such as AMPS), which transmit and receive analog based communication signals.

Although FIG. 1 illustrates a single base station 112, two satellites 116, and two gateways 120, other numbers of these elements may employed to achieve a desired communications capacity and geographic scope. For example, an exemplary implementation of WCS 100 includes 48 or more satellites, traveling in eight different orbital planes in low earth orbit to service a large number of user terminals 124.

The terms base station and gateway are also sometimes used interchangeably, each being a fixed central communication station, with gateways, such as gateways 120, being perceived in the art as highly specialized base stations that direct communications through satellite repeaters while base stations (also sometimes referred to as cell-sites), such as base station 112, use terrestrial antennas to direct communications within surrounding geographical regions.

User terminals 124 each have or comprise apparatus or a wireless communication device such as, but not limited to, a cellular telephone, a wireless handset, a data transceiver, or a paging or position determination receiver. Furthermore each of user terminals 124 can be hand-held, portable as in vehicle mounted (including cars, trucks, boats, trains, and planes) or fixed, as desired. For example, FIG. 1 illustrates user terminal 124a as a fixed telephone, user terminal 124b as a hand-held portable device, and user terminal 124c as a vehicle-mounted device.

In addition, the teachings of the invention are applicable to wireless devices such as one or more data modules or modems which may be used to transfer data and/or voice traffic, and may communicate with other devices using cables or other known wireless links or connections, for example, to transfer information, commands, or audio signals. In addition, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as ‘users’ and ‘mobiles’ in some communication systems, depending on preference.

User terminals 124 engage in wireless communications with other elements in WCS 100 through CDMA communications systems. However, the present invention may be employed in systems that employ other communications techniques, such as TDMA, and Frequency Division Multiple Access (FDMA), or other waveforms or techniques as listed above.

Generally, beams from a beam source, such as base station 112 or satellites 116, cover different geographical areas in predefined patterns. Beams at different frequencies, also referred to as CDMA channels or ‘sub-beams,’ can be directed to overlap the same region. It is also readily understood by those skilled in the art that beam coverage or service areas for multiple satellites, or antenna patterns for multiple base stations, might be designed to overlap completely or partially in a given region depending on the communication system design and the type of service being offered, and whether space diversity is being achieved.

FIG. 1 illustrates several exemplary signal paths. For example, communication links 130a-130c provide for the exchange of signals between base station 112 and user terminals 124. Similarly, communications links 138a-138d provide for the exchange of signals between satellites 116 and user terminals 124. Communications between satellites 116 and gateways 120 are facilitated by links 146a-146d.

User terminals 124 are capable of engaging in bidirectional communications with base station 112 and/or satellites 116. As such, communications links 130 and 138 each include a forward link and a reverse link. A forward link conveys information signals to user terminals 124. For terrestrial-based communications in WCS 100, a forward link conveys information signals from base station 112 to a user terminal 124 across a link 130. A satellite-based forward link in the context of WCS 100 conveys information from a gateway 120 to a satellite 116 across a link 146 and from the satellite 116 to a user terminal 124 across a link 138. Thus, terrestrial-based forward links typically involve a single wireless signal path or link, while satellite-based forward links typically involve two wireless paths or links.

In the context of WCS 100, a reverse link conveys information signals from a user terminal 124 to either a base station 112 or a gateway 120. Similar to forward links in WCS 100, reverse links typically require a single wireless connection for terrestrial-based communications and two wireless connections for satellite-based communications. WCS 100 may feature different communications offerings across these forward links, such as Low Data Rate (LDR) and High Data Rate (HDR) services. An exemplary LDR service provides forward links having data rates from 3 kilobits per second (kbps) to 9.6 kbps, while an exemplary HDR service supports data rates as high as 604 kbps or more.

HDR service may be bursty in nature. That is, traffic transferred across HDR links may suddenly begin and end in an unpredictable fashion. Thus, in one instant, an HDR link may be operating at zero kbps, and in the next moment operating at a very high data rate, such as 604 kbps.

As described above, WCS 100 performs wireless communications according to CDMA techniques. Thus, signals transmitted across the forward and reverse links of links 130, 138, and 146 convey signals that are encoded, spread, and channelized according to CDMA transmission standards. In addition, block interleaving is employed across these forward and reverse links. These blocks are transmitted in frames having a predetermined duration, such as 20 milliseconds.

The base station 112 and the gateways 120 can adjust the power of the signals that they transmit across the forward links of WCS 100. This power (referred to herein as forward link transmit power) may be varied according to user terminal 124 and according to time. This time varying feature may be employed on a frame-by-frame basis. Such power adjustments are performed to maintain forward link bit error rates (BER) within specific requirements, reduce interference, and conserve transmission power.

For example, gateway 120a, through satellite 116a, may transmit signals to user terminal 124b at a different forward link transmission power than it does for user terminal 124c. Additionally, gateway 120a may vary the transmit power of each of the forward links to user terminals 124b and 124c for each successive frame.

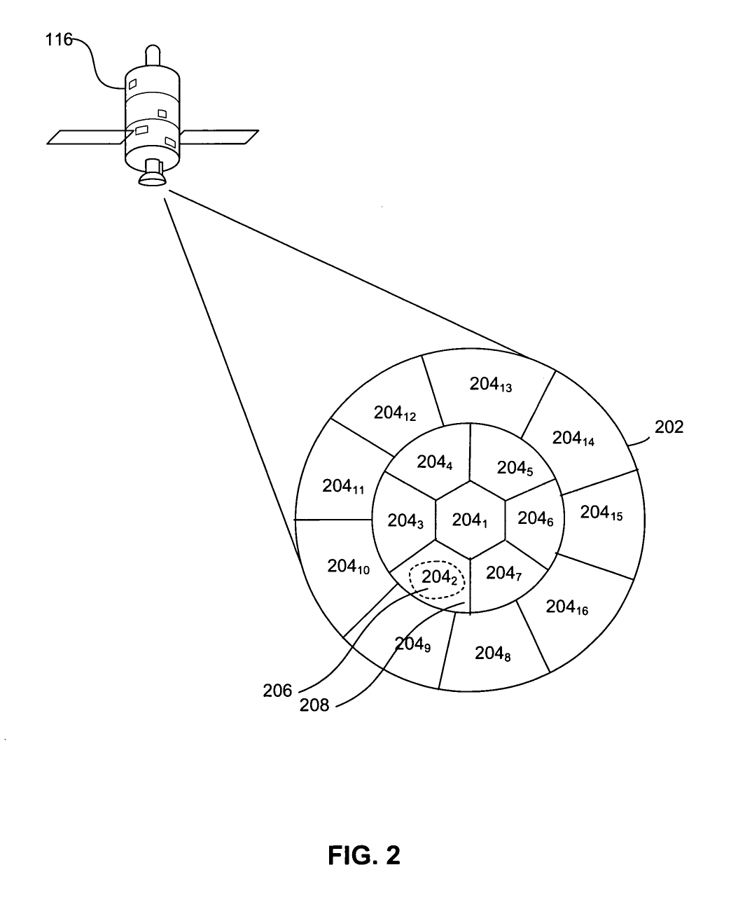

FIG. 2 illustrates an exemplary satellite beam pattern 202, also known as a footprint. As shown in FIG. 2, the exemplary satellite footprint 202 includes sixteen beams 204₁-204₁₆. Each beam covers a specific geographical area, although there usually is some beam overlap. The satellite footprint shown in FIG. 2 includes an inner beam (beam 204₁), middle beams (beams 204₂-204₇), and outer beams (beams 204₈-204₁₆). Beam pattern 202 is a configuration of particular predefined gain patterns that are each associated with a particular beam 204.

Beams 204 are illustrated as having non-overlapping geometric shapes for purposes of illustration only. In fact, beams 204 each have gain pattern contours that extend well beyond the idealized boundaries shown in FIG. 2. However, these gain patterns are attenuated beyond these illustrated boundaries such that they do not typically provide significant gain to support communications with user terminals 124.

Beams 204 may each be considered to have different regions based on their proximity to other beam(s) and/or position within other beam gain pattern(s). For example, FIG. 2 illustrates beam 204₂ having a central region 206 and a crossover region 208. Crossover region 208 includes portions of beam 2042 that are in close proximity to beams 204₁, 204₃, 204₇, 204₈, 204₉, and 204₁₀. Because of this proximity, user terminals 124 within crossover region 208 (as well as similar regions in other beams) are more likely to handoff to an adjacent beam, than are user terminals 124 in central region 206. However, user terminals 124 within handoff probable regions, such as crossover region 208, are also more likely to receive interference from communications links in adjacent beams 204.

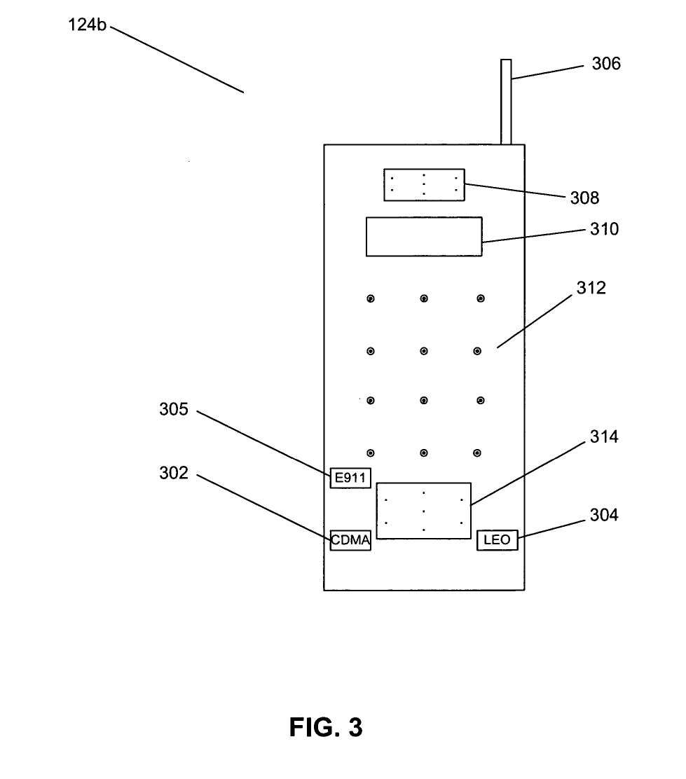

FIG. 3 is a more detailed illustration of the exemplary mobile phone 124b used in the instant invention. As stated above, the mobile phone 124b is a multi-mode or multi-band mobile phone, capable of operating in accordance with a number of wireless communication standards. Although the present application focuses primarily on the applicability of CDMA IS-95 and LEO satellite communications, it is not limited to such standards. Many other air link standards can be accommodated, such as wideband CDMA (WCDMA), global system for mobile communications (GSM), or any other suitable wireless communication standard.

The exemplary mobile phone 124b of FIG. 3 includes an antenna 306 for operating at RF frequencies compatible with the air link standards associated with the WCS 100. The exemplary mobile phone 124b includes a number of mode select switches 302, 304, and 305 that are used to select between the different air link standards compatible with the mobile phone 124b and the WCS 100. Finally, the exemplary mobile phone 124b includes other standard features, such as an earphone 308, a display panel 310, a keypad 312, and a microphone 314. The mode select switch 302 is used to select, for example, a terrestrial air link communication mode and the mode select switch 304 is used to select a satellite air link communication mode. The mode select switch 305 is used to activate an E911 emergency response mode.

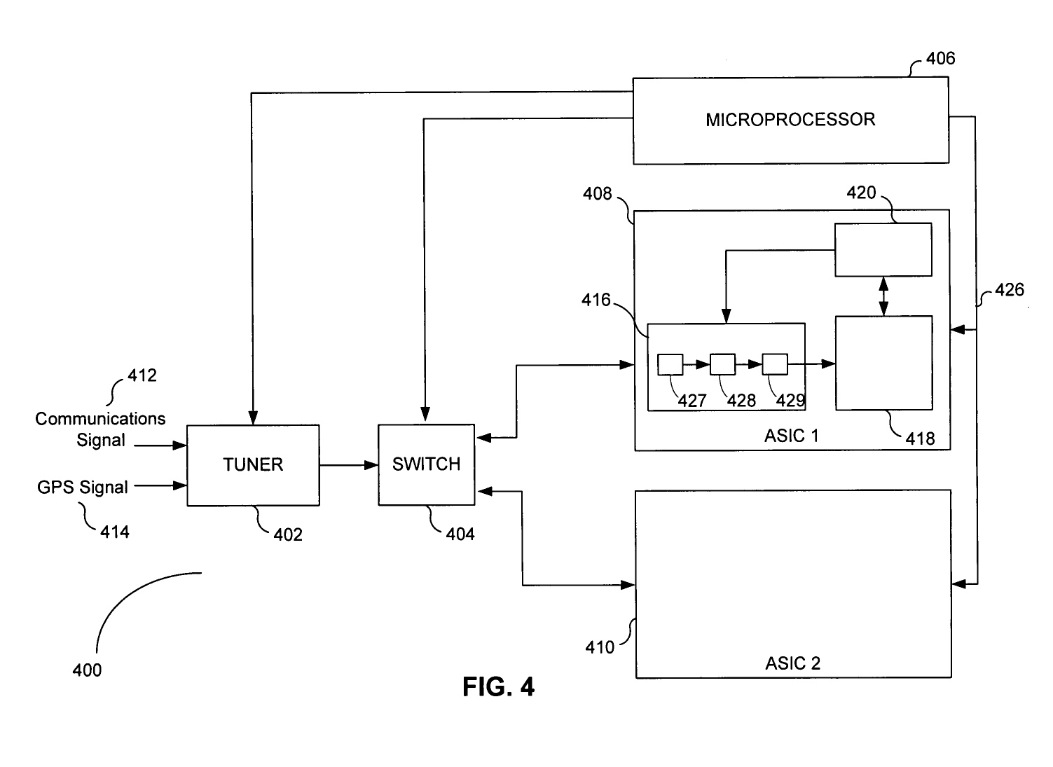

As stated above, the FCC requires that mobile phone service providers be able to provide position information within predetermined parameters for all 911 calls placed using mobile phones, such as the mobile phone 124b. In order to satisfy the requirement of providing position information for E911 services, the WCS 100 utilizes information provided by the LEO satellites 116a and 116b and by GPS satellites (not shown). The mobile phone 124b can implement multi-mode functionality, required to process information from both the LEO satellite and the GPS satellites, using a variety of signal processing circuits or functional circuit elements, controllers, or modules such as receiver/transmitters, correlators, and modulator/demodulators, as shown in FIG. 4. Typically, a single software reconfigurable Application Specific Integrated Circuit (ASIC), software defined radio (SDR), or a Field Programmable Gate Array (FPGA) type radio is used. Alternatively, the phone can use two or more ASICs or sets of circuits or devices, each dedicated to accomplishing a specific task. FIG. 4 is a block diagram illustration of a multi-mode phone implemented by using multiple ASICs.

In FIG. 4, a mobile phone control section 400 includes a tuner 402, a tuner switch 404, and a processor or controller or control element 406. Also included is an ASIC 408 and an ASIC 410. The ASIC 408 is dedicated to processing communication signals associated with, for example, IS-95 systems such as the WCS 100. The ASIC 410 is dedicated to processing signals associated with the GPS system. The switch 404, based upon a signal from the processor 406, switches the tuner 402 between the ASIC 408 and the ASIC 410. For purposes of illustration only, the ASIC 408 will be referred to as the communications ASIC and the ASIC 410 will be referred to as the GPS ASIC. The tuner 402, in accordance with an instruction signal from the microprocessor 406, is set up to receive either a communications input signal 412 or a GPS input signal 414 respectively associated with the communications ASIC 408 and the GPS ASIC 410. The communications signal supports user communication through the WCS system 100 and the GPS signal supports E911 related functions.

The ASIC 408 includes a transceiver path 416, an ASIC controller 418, and a memory 420. The memory 420 stores data associated with operation of the transceiver path 416, the controller 418 and data required for processing the communications signal 412. The transceiver path 416 includes, for example, a receiver/transmitter 427, a correlator 428 configured to perform signal searches, and a modulator/demodulator 429. The ASIC 410 similarly includes a transceiver path and an ASIC controller (not shown). Operation of the ASIC 408 and the ASIC 410 is controlled by the microprocessor 406 using control signals passed along control lines 426. The control lines 426 permit the passing of a control signal from the processor 406 to the communication ASIC 408 and the GPS ASIC 410. The control lines 426 also permit the sharing of housekeeping data, such as system time, between the ASICs 408 and 410.

During processing of a communications call in accordance with any of the aforementioned air links standards, such as CDMA, a control signal from the microprocessor 406 establishes a connection between the communications ASIC 408 and the tuner 402 using the switch 404. Based upon another control signal provided by the microprocessor 406 and search information forwarded by the transceiver path 416, the correlator 428 searches for a pilot signal associated with the communications signal 412. When the pilot signal is found and its phase information has been obtained, this information can be used by the ASIC 408 to demodulate and decode the synchronization message. As previously stated, the synchronization message contains, among other things, the identification of the associated satellite beam or base station and is used to facilitate assignment of the mobile phone 124b to a specific traffic channel. Once assigned to a traffic channel, the mobile phone can transmit and receive communications data. In accordance with conventionally used protocols, the traffic channel carries communications data in frames having a frame length of 20 milliseconds (ms). However, other frame lengths can be used as desired for specific system designs, as would be well known.

If an emergency occurs and the user activates the E911 feature of the mobile phone 124b by actuation of the mode select switch 305 shown in FIG. 3, a control signal forwarded by the microprocessor 406 will establish a connection between the GPS ASIC 410 and the tuner 402 using the switch 404. Another control signal will instruct the tuner 402 to tune to receive the GPS signal 414. The GPS ASIC 410 will then perform all of the known functions necessary to fulfill the requirements of E911 call processing, such as determining the user's position. While this period of interruption facilitates fulfillment of the E911 requirements, it consequently interrupts reception of the communications signal 412 and severely impacts the user ongoing communications call.

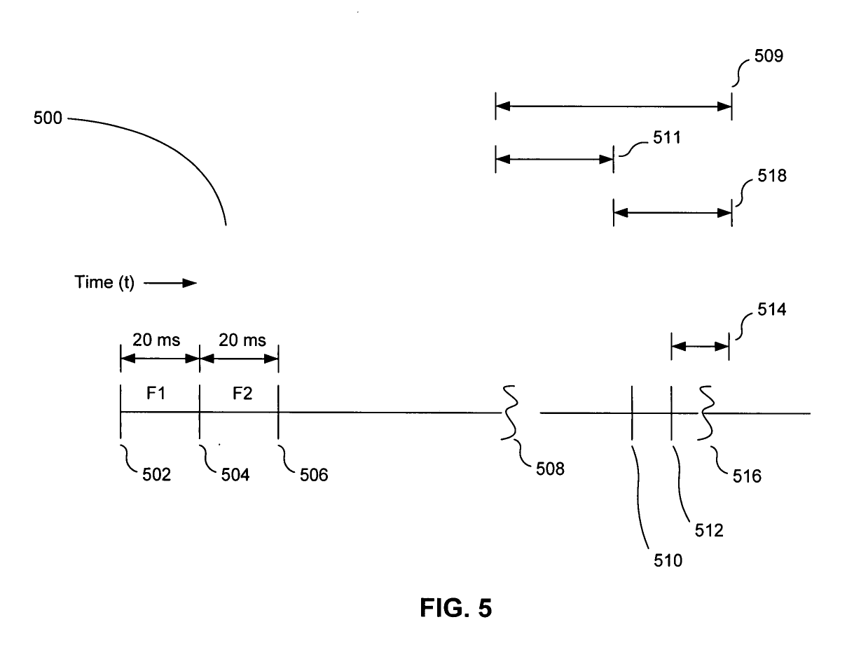

FIG. 5 is an exemplary timeline that illustrates the sequence of E911 events and their potential interruption to traffic channel communication within the mobile phone 124b. In FIG. 5, a traffic channel timeline 500 shows reception of a first 20 ms communications data frame F1 at a time 502 and a second 20 ms communications data frame F2 at a time 504 associated with the communications signal 412. The frame F2 is shown to have a frame termination boundary 506. The communications data frames F1 and F2 carry communications data, such as speech, associated with the users ongoing communications call. At a time 508, the tuner 402 de-tunes from the communications signal 412 to receive the GPS signal 414, temporarily interrupting the communications call for a time period 509, which can be up to several seconds.

At a time 510, the GPS functions associated with the E911 call conclude and the microprocessor 406 re-establishes the communications link between the communications ASIC 408 and the tuner 402. The entire E911 call processing lasts for a time period 511, which began with the de-tuning 508 and ended with the conclusion of the GPS functions 510. At a time 512, the tuner 402 re-tunes and the communications ASIC 408 attempts to reacquire the communications signal 412. The re-acquisition process continues for a time period 514, which can range from about 100 ms to more than a half second. At a time 516, the ASIC 408 re-acquires the communications signal 412 and the user resumes the ongoing communications call over the traffic channel. A time window 518 defines a time period between conclusion of the GPS functions 510 and resumption of communication over the traffic channel 516.

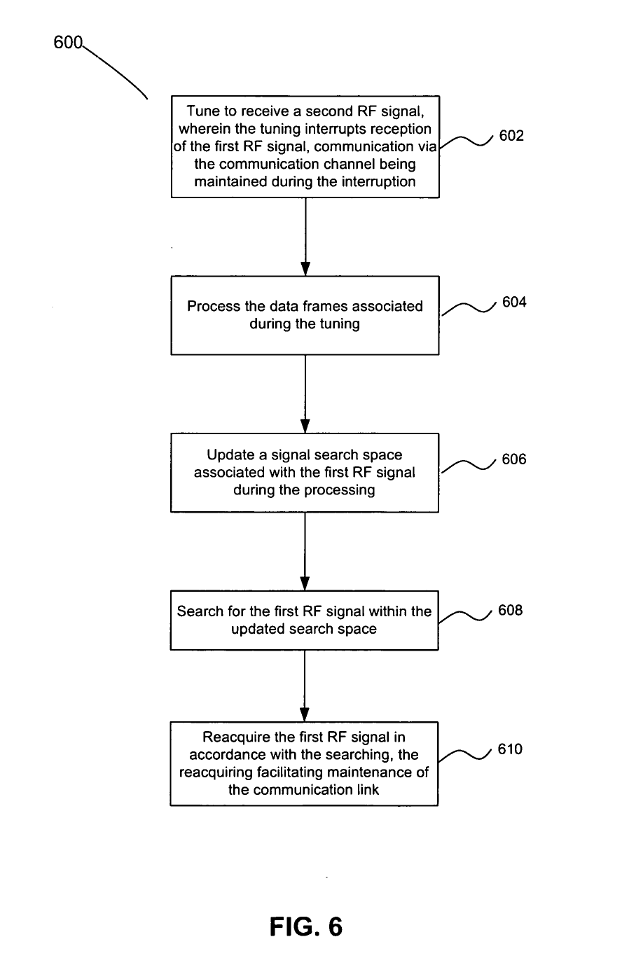

The present invention provides a number of exemplary techniques to reduce the impact of the time period 518 to ongoing communication on the traffic channel during E911 call processing. In discussion of these techniques, a back ground assumption is made that the mobile phone and the associated base station or satellite beam have already exchanged messages setting up the call and informing the phone of the visible portion of the GPS satellite constellation. What is necessary, however, is that the phone must leave the traffic channel to perform the GPS measurement using the GPS ASIC 410. While doing this, it preferably will not drop the ongoing communications call supported by the communications ASIC 408. FIG. 6 depicts one of the exemplary techniques.

In FIG. 6, a method 600 is shown which facilitates the interruption and return of communication over the traffic channel during an E911 call. More particularly, the method 600 places the mobile phone 124b in an emergency mode after a unit of software operating in the microprocessor 406, realizes that the communications signal 412 has been interrupted. This unit of software controls the searching and acquisition functions of the communications ASIC 408. The environment that invokes this mode is similar to the environment created when the mobile phone user walks beneath a bridge, temporarily cutting off the incoming communications signal. For purposes of illustration, the method 600 is also known as the bridge block mode, or the emergency mode.

Since the communications ASIC 408 and the GPS ASIC 410 share system time using the control lines 426, the GPS ASIC 410 continues to receive detailed system time and clock level time from the ASIC 408 supplied by the communications signal 412. Signal tracking loops associated with the ASIC 410 are therefore able to “mark time” with knowledge of this detailed system time and take account of related errors, such as caused by Doppler shifts. This timing and error information is later factored into known calculations associated with performing the method 600.

As shown in FIG. 6 and mentioned above, when the E911 call is processed, the tuner 402 tunes to receive the GPS signal 414, as depicted in block 602. This process temporarily interrupts reception of the communications signal 412 at least for the length of the GPS functions time period 511, as illustrated in FIG. 5. If, however, the time period 511 is less than or equal to a predetermined amount of time, such as 1 second, the controller 418 will not recognize that the communications signal 412 is no longer being received. The controller 418 will, therefore, attempt to temporarily maintain communications on the assigned traffic channel as also indicated in block 602. Consequently, the communications ASIC 408 will continue to process the remaining data frames associated with the communications signal 412 as though the communications signal was still being received, as depicted in block 604. If the time period 511 is significantly longer, a probability exists that communication over the assigned traffic channel will be completely lost.

When the controller 418 finally recognizes the communications signal 412 is no longer being received by the tuner 402, it will attempt to re-acquire the communications signal 412. Reacquisition begins by the controller 418 instructing the correlator 428 to perform successive searches within a search region or window where the pilot signal, associated with communications signal 412, is expected to be. This search is based on the last available pilot signal information stored in the memory 420 and available signal doppler information.

As the correlator 428 performs its search, it updates the data stored in the memory 420 with updated information derived from the current search. The correlator will then continue its search for the pilot signal within the updated search region, as depicted in block 608. The correlator will eventually re-acquire the communications signal as indicated in block 610. Since the controller 418 did not recognize an interruption of reception of the communications signal 412, re-acquisition of the communications signal 412 will permit resumption of communications over the originally assigned traffic channel and the previous communications state.

Resumption of communication over the assigned traffic channel precludes the need for the ASIC 408 to complete all of the steps normally required for re-acquisition, such as the traffic channel assignment process. This advantage reduces the possibility of the mobile phone user experiencing any significant call delays resulting from the E911 call processing.

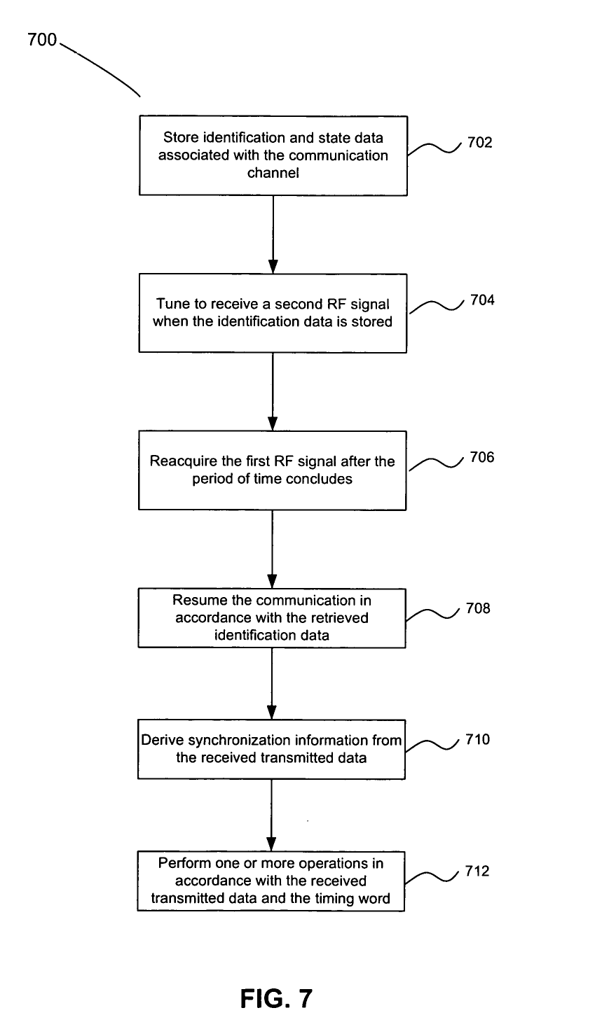

The bridge block mode, represented by the method 600, can be easily incorporated into firmware, software code, or other control and command functions or elements of a conventional mobile phone. More importantly, the bridge block mode prevents termination of the current communications state, thereby permitting the phone to maintain communications using the assigned traffic channel. As noted above, however, if the time period 511 is significantly longer, such as several seconds, the phone may experience a complete interruption of communication and loss of its current traffic channel assignment. One known rationale for the complete interruption of communication is the activation of fade timers, which automatically terminate calls after predetermined amounts of time. FIG. 7 presents an exemplary method 700 to reduce the re-acquisition time in the event of a complete loss of communication.

In FIG. 7, the method 700, also referred to as the cold-reacquisition method, recognizes conclusion of the GPS measurement functions at a time 510 shown in FIG. 5. The method 700, unlike the method 600 of FIG. 6, assumes that the time period 511 will totally interrupt communications over the traffic channel and terminate the communications state. Although the correlator 428 will attempt to re-acquire the communications signal 412, it will not find it before termination of the communications state.

As shown in FIG. 7, the ASIC 408 periodically stores the identification and communications state data associated with communication using the communications signal 412 as depicted in block 702. Included in the stored information, for example, is the pilot signal phase, base station, satellite beam identification, system time, and traffic channel assignment, etc. Thus, when the E911 function is activated, the identification and state information will have already been stored and can be retrieved to assist in the signal re-acquisition process.

After the E911 call processing function begins at the time 508 of FIG. 5, the processor 406 instructs the tuner 402 to tune to receive the GPS signal 414 as indicated in block 704 of FIG. 7. After expiration of the time period 511, representing the conclusion of the E911 call processing functions, the controller 418 instructs the tuner to retune to receive the communications signal 412, as depicted in block 706.

Although at this time, the ASIC 408 has completely lost the communications state and the assigned traffic channel, it can retrieve the stored identification and state data from the memory 420 and essentially jump start the acquisition process, as indicated in block 708. That is, the ASIC 408 can eliminate the time normally required to achieve acquisition, synchronization, and channel assignment etc. from a cold start, by loading this data from memory and using this information as a starting point for re-acquiring the communications signal 412. Further, since the ASIC 408 does not need to maintain the communications state during the time period 511 of FIG. 5, it can be powered down to preserve battery life. At the time 510, the processor 406 instructs the ASIC 408 to wake-up from its powered down mode and re-acquire the communications signal 412.

When the ASIC 408 wakes-up, it will initially attempt to perform a normal acquisition to re-acquire the communication signal 412. However, the processor 406 will intervene and remind the controller 418 of the associated pilot signal's phase, the base station identification, the traffic channel assignment, etc., based upon the identification and state data retrieved from the memory 420.

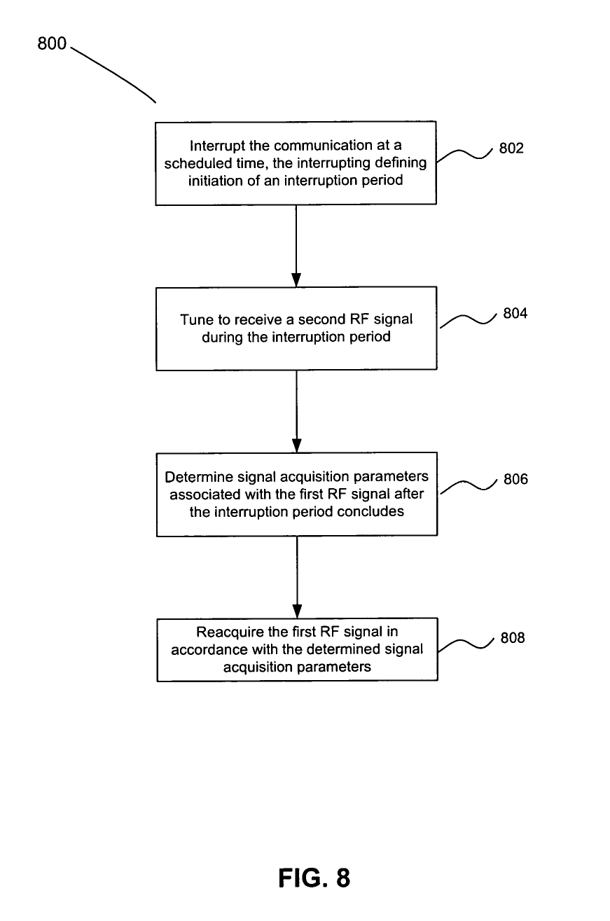

By using this identification and state data, the ASIC 408 will be able to skip several of the steps normally required for signal acquisition and, for example, jump from the pilot channel directly to the traffic channel, facilitating a time savings of up to several seconds. This feature, however, can consequently create the need to extend the fade timers. The ASIC 408 can then also, for example, readjust its symbol clock to re-acquire the signal before expiration of the fade timers. For purposes of illustration only, one exemplary technique the ASIC 408 can use to identify the traffic channel is use of the corresponding Walsh codes discussed above. On some occasions, however, communication interruptions can be anticipated. During these anticipated periods of interruption, where the length of the interruption is known apriorily, the ASIC 408 can be programmed to precisely recall all previous communication states and resume communication. FIG. 8 represents such an exemplary technique.

FIG. 8 depicts a method 800, also referred to as the slotted traffic method, for re-acquiring the communications signal 412 and resuming communication over the traffic channel under pre-programmed conditions. In other words, the method 800 can be used when the length of the time period 511 is predetermined and well known. Consequently, the method 800 can be activated with complete predictability and can, therefore, be used to shut down the ASIC 408 resources, such as the demodulator 429, to preserve battery life. During the time period 511 of FIG. 5, normal communication is interrupted and the ASIC 408 enters a dormant state for the predetermined amount of time in response to commands or program instructions, as depicted in block 802 of FIG. 8. This dormant state preserves system resources, to extend battery life. Also during the dormant state, the processor 406 uses control signals or commands to instruct the tuner 402 to adjust the frequency it is tuned to in order to receive the GPS signal 414, as indicated in block 804.

At the conclusion of the preprogrammed amount of time, the ASIC 408 wakes up, and begins to perform calculations in order to re-acquire the communications signal 412. For example, the ASIC 408 begins to search for the associated pilot signal, determine Doppler error associated with the pilot signal and accurately determine the system time. The pilot signal can be located using the techniques discussed above. Also, the base station and/or satellite beam assignment can be determined from the Walsh codes as discussed. An exemplary technique for determining the system time is simply retrieving the length of the time period 511 and advancing the system time by this amount plus any offset used to compensate for Doppler shifts or error. Based upon these parameters, the correlator 428 will search for and acquire the communications signal 412, as described in blocks 806 and 808.

The predictability of the slotted traffic method 800 makes the process of re-acquiring the communications signal 412 and returning to communication over the traffic channel during the E911 process more deterministic. Consequently, the impact of E911 functions to the user's ongoing communication can be minimized.

Similarly, the emergency mode method 600 and the cold-reacquisition method 700 operate to minimize the degree of impact that the E911 process could potentially inflict upon the operation of the mobile phone 124b. The methods and system of the present invention can be implemented using many of the available air link standards, such as the LEO communications standard or the WCDMA standards and with minimal changes to existing mobile phone hardware configurations. When implemented, the techniques of the present invention preserve system resources and increase the user's level of confidence that the phone can continue to operate during potentially problematic periods.

The foregoing description of the preferred embodiments provides an illustration and description, but is not intended to be exhaustive or to limit the invention to the precise form disclosed. Modifications and variations are possible consistent with the above teachings, or may be acquired from practice of the invention.

1. A method of establishing a communications link using a device in a communications system having at least one communication channel, the device (i) including a processor, a tuner, and a demodulator and (ii) being configured to establish communication with the communications system, the device communicating using the communication channel based upon a received first Radio Frequency (RF) signal, the method comprising:
interrupting the communication at a scheduled time, the interrupting defining initiation of an interruption period;
tuning to receive a second RF signal during the interruption period;
determining signal acquisition parameters associated with the first RF signal after the interruption period concludes; and
re-acquiring the first RF signal in accordance with the determined signal acquisition parameters.

2. The method of claim 1, wherein the device is a mobile phone.

3. The method of claim 1, wherein the demodulator is deactivated during the interruption period.

4. The method of claim 1, wherein the second RF signal is associated with obtaining device position location information.

5. The method of claim 4, wherein the position location information supports an E911 requirement.

6. The method of claim 1, wherein the determining includes calculating a first RF signal Doppler, calculating a present system time, and calculating a search space for the first RF signal.

7. The method of claim 6, wherein calculating the first RF signal doppler includes quantifying an amount of error, the amount of error including at least one from a group including motion error and synthesizer clock error.

8. The method of claim 6, wherein the scheduled time is an initial system time, and wherein calculating the present system time includes advancing the initial system time by an amount equal to a sum of the interruption period and the quantified amount of error, the advanced initial system time defining the present system time.

9. The method of claim 1, further comprising resuming communication over the communication channel when the first RF signal is re-acquired.

10. An apparatus for establishing a communications link using a device in a communications system having at least one communication channel, the device (i) including a processor, a tuner, and a demodulator and (ii) being configured to establish communication with the communications system, the device communicating using a communication channel based upon a received first Radio Frequency (RF) signal, the apparatus comprising:
means for interrupting the communication at a scheduled time, the interrupting defining an interruption period;
means for tuning to receive a second RF signal during the interruption period;
means for determining signal acquisition parameters associated with the first RF signal after the interruption period concludes; and
means for attempting to re-acquire the first RF signal in accordance with the determined signal acquisition parameters.

11. The apparatus of claim 10, wherein the interruption period includes an initiation point and a termination point.

12. A computer readable medium carrying one or more sequences of one or more instructions for execution by one or more processors, the one or more processors included in a system configured to establish a communications link using a device in a communications system having at least one communication channel, the device (i) including a processor, a tuner, and a demodulator and (ii) being configured to establish communication with the communications system, the device communicating using the communication channel based upon a received first Radio Frequency (RF) signal, the instructions when executed by the one or more processors, cause the one or more processors to perform the steps of:
interrupting the communication at a scheduled time, the interrupting defining initiation of an interruption period;
tuning to receive a second RF signal during the interruption period;
determining signal acquisition parameters associated with the first RF signal after the interruption period concludes; and
attempting to re-acquire the first RF signal in accordance with the determined signal acquisition parameters.

13. The computer readable medium of claim 12, wherein the interrupting further includes defining termination of an interruption period.

14. A method of establishing a communications link using a device in a communications system having at least one communication channel, the device (i) including a processor, a tuner, and a demodulator and (ii) being configured to establish communication with the communications system, the device communicating using a communication channel based upon a received first Radio Frequency (RF) signal, the method comprising:
storing identification and state data associated with the communication channel;
tuning to receive a second RF signal when the identification data is stored, the tuning interrupting reception of the first RF signal for a period of time;
re-acquiring the first RF signal after the period of time concludes;
retrieving the stored identification and state data when the first RF signal is reacquired; and
resuming the communication in accordance with the retrieved identification and state data.

15. The method of claim 14, wherein the device is a mobile phone.

16. The method of claim 14, wherein the identification data includes a pilot signal phase, identification of at least one of (i) an associated base station and (ii) a satellite beam, identification of the traffic channel, and a type of service.

17. The method of claim 16, wherein the position location information supports an E911 requirement.

18. The method of claim 14, wherein the second RF signal is associated with obtaining device position location information.

19. The method of claim 14, wherein the re-acquiring step includes (i) determining a first RF signal search space, (ii) searching within the determined first RF signal search space, and (iii) selecting the first RF signal during the search.

20. An apparatus for establishing a communications link using a device in a communications system having at least one communication channel, the device (i) including a processor, a tuner, and a demodulator and (ii) being configured to establish communication with the communications system, the device communicating using a communication channel based upon a received first Radio Frequency (RF) signal, the apparatus comprising:
means for storing identification and state data associated with the communication channel;
means for tuning to receive a second RF signal when the identification data is stored, the means for tuning interrupting reception of the first RF signal for a period of time;
means for re-acquiring the first RF signal after the period of time concludes;
means for retrieving the stored identification and state data when the first RF signal is reacquired; and
means for resuming the communication in accordance with the retrieved identification and state data.

21. The apparatus of claim 20, wherein the processor includes one or more circuit types from the group including application specific integrated circuits, software defined radios, and field programmable gate arrays.

22. The apparatus of claim 20, wherein the communication channel is a traffic channel.

23. A computer readable medium carrying one or more sequences of one or more instructions for execution by one or more processors, the one or more processors included in a system configured to establish a communications link using a device in a communications system having at least one communication channel, the device (i) including a processor, a tuner, and a demodulator and (ii) being configured to establish communication with the communications system, the device communicating using a communication channel based upon a received first Radio Frequency (RF) signal, the instructions when executed by the one or more processors, cause the one or more processors to perform the steps of:
storing identification and state data associated with the communication channel;
tuning to receive a second RF signal when the identification data is stored, the tuning interrupting reception of the first RF signal for a period of time;
re-acquiring the first RF signal after the period of time concludes;
retrieving the stored identification and state data when the first RF signal is reacquired; and
resuming the communication in accordance with the retrieved identification and state data.
